(19) United States
(12) Patent Application Publication
(10) Pub. No.: US 2024/0356221 A1
(43) Pub. Date: Oct. 24, 2024

(54) SYSTEMS AND METHODS FOR RADAR WITH BROADBAND ANTENNAS

(71) Applicant: GM Cruise Holdings LLC, San Francisco, CA (US)

(72) Inventors: Benedikt Hubertus SCHULTE, Neubiberg (DE); Sebastian MANN, München (DE); Andre GIERE, Oberpframmern (DE)

(21) Appl. No.: 18/304,169

(22) Filed: Apr. 20, 2023

(30) Foreign Application Priority Data
Apr. 18, 2023 (EP) 23168597.5

(51) Int. Cl. H01Q 5/357; H01Q 1/42

(52) U.S. Cl. CPC H01Q 5/357; H01Q 1/422

(57) ABSTRACT

Various technologies described herein pertain to systems and methods for broadband radar(s) having broadband antenna systems including, for example, antennas and components. In one aspect, a system is disclosed having a dielectric structure that includes two or more dielectric heights and/or effective dielectric constant values. A first dielectric height and/or effective dielectric constant value is used for a transmission feed portion of the system and a second dielectric height and/or effective dielectric constant value is used for an antenna portion of the system. In one embodiment, the second dielectric height is greater than the first dielectric height and is selected to provide the antenna portion with a selected frequency range.

### RELATED APPLICATION

This application claims priority to European Patent Application No. 23168597.5, filed on Apr. 18, 2023, and entitled “SYSTEMS AND METHODS FOR RADAR WITH BROADBAND ANTENNAS”. The entirety of this application is incorporated herein by reference.

### BACKGROUND

Radar has been used to assist various vehicle functions such as, for example, collision avoidance, cruise or flight control, and the positioning and movement of objects. Radar works by emitting high-frequency radio waves and measuring the reflection, or echo, of the waves from nearby objects. The time delay between the transmission and reception of the waves can be used to determine the distance, speed, and direction of the object. This information is processed by the vehicle's onboard computer to provide real-time information to enhance vehicle navigation and safety.

Unmanned Aerial Vehicles (UAVs), also known as drones, are aircraft flown without a human pilot onboard. They are used for various purposes such as, for example, military operations, surveying, delivery, photography, and recreation. UAVs can be controlled by a remote or automated system. UAVs come in different sizes, ranging from small hobby drones to large military drones.

Radars typically include one or more antennas tuned to transmit and/or receive the frequency of radio waves used by the radar system. However, it has been difficult to fabricate broadband, low profile (or planar) antennas for radar applications operating in, for example, Ku-band frequencies (i.e., about 12 GHz to 18 GHz). It has also been difficult to fabricate such antenna systems that are also light in weight and do not occupy significant space on printed circuit boards or assemblies.

What is desired are electronic systems and methods that address these and other issues related to radar systems for UAVs and other vehicles.

### SUMMARY

This summary presents a simplified overview to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

Various technologies described herein pertain to systems and methods for broadband radar systems including, for example, antennas and components. In one aspect, a system is disclosed having a dielectric structure that includes varying substrate heights and/or varying effective dielectric constants. A first substrate height is used for a transmission feed portion of the system and a second substrate height is used for an antenna portion of the system. In one embodiment, the second substrate height is greater than the first substrate height and is selected to provide the antenna portion with a particular frequency range that can include, for example, the Ku-band (e.g., about 12 GHz to 18 GHz).

In another aspect, an electronic circuit assembly having a substrate including a feed portion, transition portion, and antenna portion is provided. The feed portion includes a first metallization layer, a first ground layer, and a first dielectric structure having a first height between the first metallization layer and the first ground layer. The transition portion includes a tapered portion of the first metallization layer, a second ground layer, and a second dielectric structure having a second height between the first metallization layer and the second ground layer. The second height includes a value greater than the first height. The antenna portion includes a portion of the first metallization layer and a portion of the second dielectric structure. The antenna portion includes an antenna element.

In yet another aspect, a method for constructing an electric circuit assembly includes the steps of providing a substrate having first, second, and third dielectric heights as well as a feed portion, transition portion, and antenna portion. The feed portion is formed by providing a first metallization layer on the first dielectric height and a second metallization layer opposite the first metallization layer. The transition portion is formed by providing a tapered portion of the first metallization layer and third metallization layer opposite the first metallization layer. The transition portion includes a second dielectric height between the first and third metallization layers. The antenna portion is formed by providing a portion of the first metallization layer with an antenna element. The antenna portion having a third dielectric height greater than the first dielectric height.

### BRIEF DESCRIPTION OF THE DRAWINGS

In the accompanying drawings which are incorporated in and constitute a part of the specification, disclosures and embodiments of the invention(s) are illustrated, which, together with a general description given above, and the detailed description given below, serve to disclose and exemplify principles of the invention(s).

FIG. 1 is a block diagram illustrating one embodiment of a system and method for broadband radar.

FIG. 2 illustrates one embodiment of a system and method having feed, transition, and antenna portions.

FIG. 3A illustrates one embodiment of a sectional view taken along the section line shown in FIG. 2.

FIG. 3B illustrates another embodiment of a sectional view taken along the section line shown in FIG. 2.

FIG. 3C illustrates yet another embodiment of a sectional view taken along the section line shown in FIG. 2.

FIG. 4 illustrates one embodiment of a partial, perspective, sectional view taken along the section line shown in FIG. 2.

FIG. 5 illustrates another embodiment of a system and method for broadband radar.

FIG. 6 illustrates one embodiment of a block diagram showing a vehicle having the system and method for broadband radar.

### DETAILED DESCRIPTION

Various technologies pertaining to radar systems and methods are now described with reference to the drawings, wherein like reference numerals are used to refer to like elements throughout. In the following description, for purposes of explanation, numerous specific details are set forth to provide a thorough understanding of one or more aspects. It may be evident, however, that such aspect(s) may be practiced without these specific details. In other instances, structures and devices are shown in block diagram form to facilitate a non-limiting description of one or more aspects of the disclosure. Further, it is to be understood that functionality that is described as being carried out by certain system components may be performed by multiple components. Similarly, for instance, a component may be configured to perform functionality that is described as being carried out by multiple components. Further, when two components are described as being connected, coupled, joined, affixed, in physical communication, etc., it is to be understood that one or more intervening components or parts can be included in such association.

Moreover, the term “or” is intended to mean an inclusive “or” rather than an exclusive “or.” That is, unless specified otherwise, or clear from the context, the phrase “X employs A or B” (or other similar phrases) is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The terms “top” and “bottom,” or “upper” and “lower,” are used herein for identification purposes. Similarly, the terms “first,” “second,” “third,” etc. are used herein for identification purposes. It is contemplated that components disclosed herein can be oriented in substantially any manner consistent with the disclosure. For instance, a top surface need not be above a bottom surface, unless specifically identified in that spatial relationship by the disclosure. Similarly, a “first” component need not come before a “second” or “third” component. Further, as used herein, the term “exemplary” is intended to mean “serving as an illustration or example of something.”

Embodiments of the present disclosure provide systems and methods for radar applications that include, for example, broadband, low profile (or planar) antennas. The frequency range of the systems includes, for example, the Ku band (e.g., about 12 GHz to 18 GHz). Other bands or frequencies can also be employed. The systems are small and light and use, for example, a microstrip or patch antenna component. A microstrip or patch antenna has a flat, rectangular metal patch (the radiating element) that is mounted on a dielectric substrate structure typically made from one or more layers of a low loss insulating material such as, for example, fiberglass, epoxy, resins, composites, FR-4 material), etc. The patch antenna is fed with a microstrip transmission line (which can be differential or single) and electromagnetic energy is radiated from the patch antenna into the surrounding environment. The antenna component can be single or plural (i.e., more than one microstrip or patch antenna).

Embodiments of the disclosure provide a broadband patch antenna that includes a metallization layer, a ground layer, and a dielectric structure having a dielectric constant value. The metallization layer preferably includes a rectangular shape having a length “L” and a width “W.” Other shapes (e.g., square, circular, elliptical, arrays, etc.) can also be used. The frequency range of the patch antenna is determined by its dimensions, including the size of the patch, the height of the dielectric structure/substrate, and the thickness of the metal layer. The following formula provides the approximate center frequency of the frequency band of operation:

$$f = \frac{c}{2 \sqrt{{ε}_{r}} ( L )}$$

where “c” is the speed of light (e.g., approx. 300,000,000 m/s), “&,” is the value of the dielectric constant (or relative permittivity) of the material(s)/structure between the patch antenna and the ground layer, and “L” is the length of the patch antenna.

Also, the height of the dielectric substrate/structure can affect the antenna's bandwidth, or the range of frequencies over which it can efficiently radiate energy. Generally, a higher substrate height can result in a higher bandwidth for an antenna.

The systems and methods for radar having broadband antenna(s) include a printed circuit board assembly having a plurality of dielectric heights and also a plurality of effective dielectric constant values “εᵣ.” For example, the antenna portion can be formed over a section of the printed circuit board having a dielectric substrate height different (e.g., higher) than other portions of the printed circuit board. This provides a particularly sized patch antenna with a broader frequency range or bandwidth in, for example, the Ku band. Other frequency bands are also contemplated within the disclosure herein. In other aspects, the antenna feed transmission lines can, for example, be fabricated over portions of the printed circuit board having a dielectric substrate height different (e.g., lower) than that of the antenna portion. In this manner, a printed circuit board can be provided with an antenna portion having a broadband antenna(s). This provides, in one embodiment, a common printed circuit board including both the receiver and/or transmitter circuitry and the antenna component, which allows the printed circuit board size and weight to be minimized compared to arrangements requiring multiple printed circuit boards (e.g., one for the radar circuitry and one for the antenna). And, in the case of systems having multiple printed circuit boards, it allows a reduced size and lighter weight printed circuit board for the broadband antenna component.

Also, the effective dielectric constant values of various sections of the printed circuit board can be modified by, for example, the height(s) of the dielectric substrate layer(s) between the metallized layer(s) and the ground layer(s). In one embodiment, the height can be determined by a single dielectric layer or the sum of multiple dielectric layers. Furthermore, in addition to the overall height of the dielectric layer(s), the individual dielectric layer(s) can have the same or different dielectric constant values.

Embodiments of the present disclosure also provide systems and methods for radar having broadband antenna(s) that reduce and/or eliminate the need for components such as balun devices. Balun (i.e., “balanced-to-unbalanced”) devices are generally a type of transformer (and/or a capacitive or inductive circuit) that is used in radar systems to transform balanced transmission lines to unbalanced transmission lines Balun devices add weight, size, and potentially power losses to radar systems. Embodiments of the disclosure instead use, for example, differential feed transmission lines having tapered dimensions (e.g., varying widths), transitional gap/spacing between pairs of differential transmission lines (e.g., mirroring) and/or insert feeds (or notch feeds) to the patch antennas to provide the desired impedance matching and balance transformation.

For example, embodiments of the disclosure use a tapered transformation from a differential microstrip line (i.e., a balanced line) to a single-ended microstrip line (unbalanced line) and two patch antennas. This arrangement provides a differential antenna consisting of two single-ended patch antennas. At the tapered transformation, a gap spacing between the differential feed transmission lines increases more and more thereby resulting in a single-ended transmission line feeding each patch antenna.

The impedance of the balanced/differential transmission line in the antenna portion having the increased substrate height remains substantially unchanged by, for example, increasing the width of the transmission line. This can be accomplished by, for example, a taper section that increases the transmission line width. The impedance matching of the unbalanced/single ended transmission line to the patch antenna can be done by, for example, an insert feed to each patch antenna. In other embodiments wherein single-ended transmission lines are used, if necessary, balun devices may still be utilized to balance the system.

These and other aspects of the disclosure provide a lightweight and compact antenna system. Wired or other external connections between the main printed circuit board and the antenna can be eliminated and/or reduced. And, certain components such as, for example, balun devices, can also be eliminated and/or reduced when differential transmission lines and/or differential feed antennas are used. These characteristics allow the radar system to have the antenna on the same printed circuit board as other components of the radar system. Additional printed circuit boards for the antenna(s) are not required and thus at least one less printed circuit board can be used. Furthermore, in systems having multiple printed circuit boards, the printed circuit board having the antenna(s) can be smaller. Hence, the radar systems can be fabricated with reduced size, components, and weight.

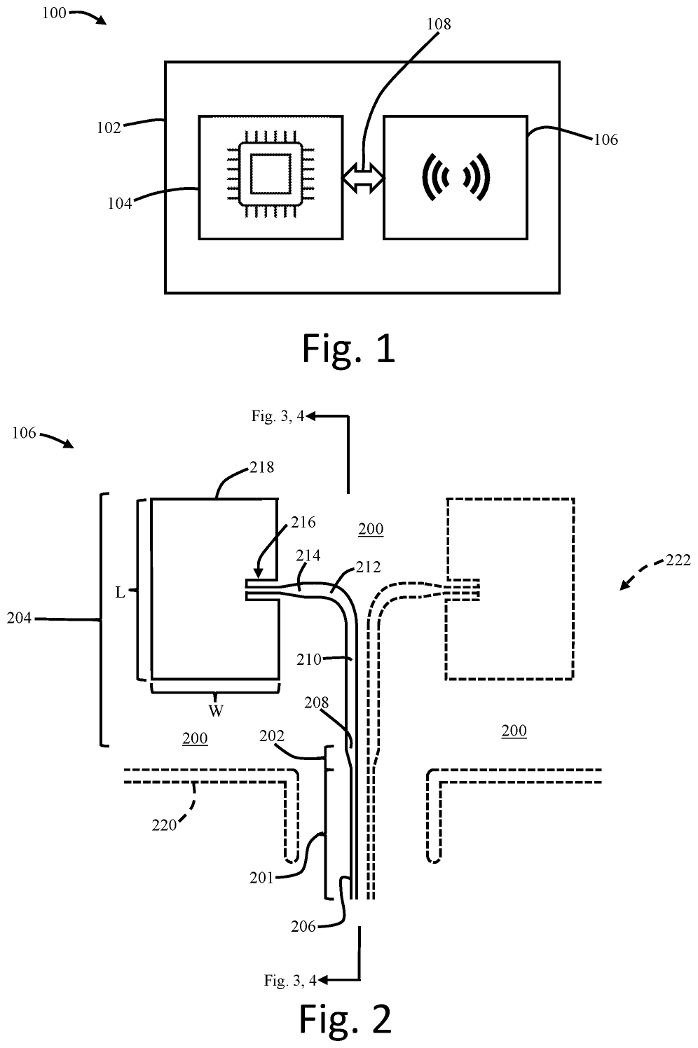

FIG. 1 is a block diagram illustrating one embodiment of a system and method 100 for radar having a broadband antenna(s). System 100 includes a substrate 102 such as, for example, one or more printed circuit boards. System 100 further can include various electronic components 104 such as, for example, digital, power, and other circuits. These components can include digital processing circuits such as microprocessors, signal processors, memories, input/output controllers, analog to digital converters, digital to analog converters, transmitters, receivers, power circuits, etc. Components 104 can also include, for example, various input/output devices including sensors, cameras, displays, motors, microphones, speakers, etc. In one embodiment, system 100 can further include, for example, an antenna system 106 that communicates 108 with components 104. Antenna system 106 can include, for example, various antenna structures including one or more microstrip or patch antennas. System 106 can operate in a variety of frequency bands including, for example, the Ku band (e.g., about 12 GHz to 18 GHz). Other frequency bands are also contemplated. System 106 can provide system 100 with functionality such as, for example, navigation and object detection and avoidance. As will be described in more detail, in one embodiment, system 100 includes components 104 and antenna system 106 on a single substrate body 102 (e.g., a printed circuit board structure). In other embodiments, system 100 can include one or more components 104 on a first substrate body (e.g., a first printed circuit board structure) and antenna system 106 on a second substrate (e.g., a second printed circuit board substrate).

FIG. 2 illustrates one embodiment of an antenna system and method 106 having feed, transition, and antenna portions 201, 202, and 204, respectively. Feed portion 201 has a first metallized microstrip line section 206 that has a generally uniform width. Transition portion 202 has a metallized transition section 208. In one embodiment, transition section 208 is tapered. The tapering has one end connected to microstrip transmission line 201 and progressively widens to a second distal end. The antenna portion 204 includes metallized microstrip line sections 210, 212, 214, and notch 216. In the embodiment shown, microstrip line section 210 has one end connected to wider end of transition section 208 and another end that transitions to metallized microstrip line section 212. In the present embodiment, microstrip line sections 210 and 212 form a curved section that changes the direction of the overall microstrip feed line. Microstrip line section 212 connects to tapered section 214. Microstrip line tapered section 214 tapers to a smaller width than microstrip line section 212 and connects to an antenna section 218 via notch or insert feed 216. Antenna portion 204 has been described as including microstrip line sections 210 and 212 and tapered section 214 for convenience. It should be noted these components can instead be described as part of a microstrip transmission feed line. The same applies to transition section 208, which is also functionally part of the microstrip transmission feed line to antenna section 218. Hence, these components need not necessarily be only associated with an antenna portion but may instead be associated with other portions such as, for example, an overall microstrip transmission line having one or more components/sections.

Tapered sections 208 and 214 change the width (or, more broadly, the dimensions) of the microstrip transmission line so that impedance matching can be accomplished. Impedance matching the transmission line to the associated transmission and/receiver circuitry reduces internal signal reflection in the transmission line and increases power efficiency and conversion to the antenna section 218. While FIG. 2 illustrates one embodiment of a metallized microstrip transmission line connected to antenna section 218, other embodiments having different dimensions and geometries are also contemplated. For example, different line widths, tapers and geometries can be used.

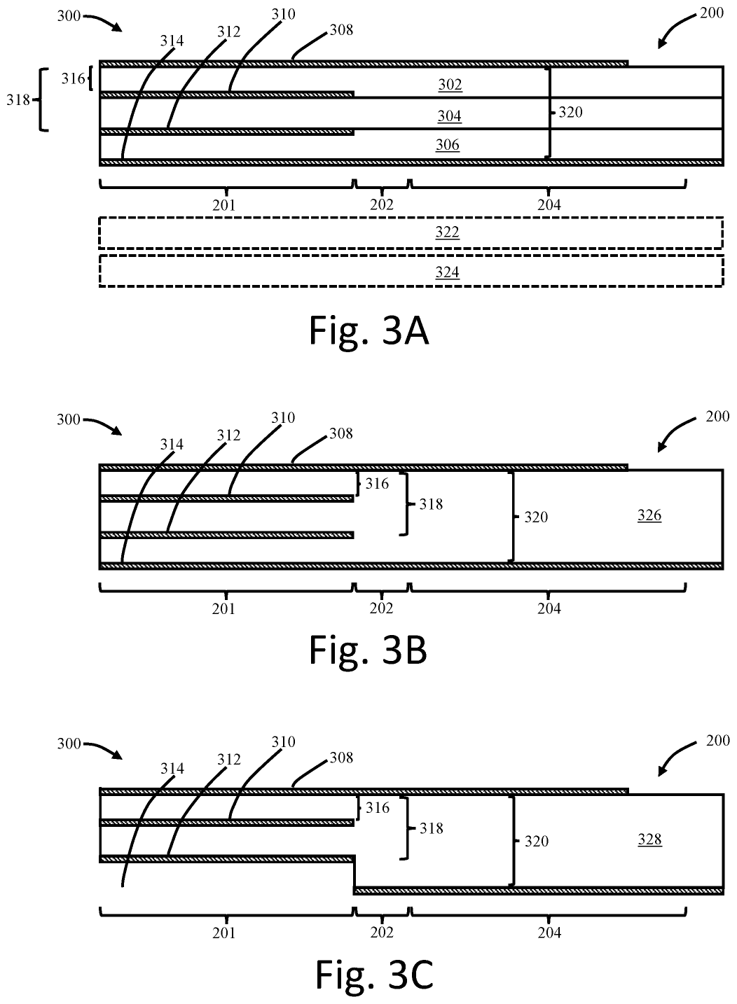

In one embodiment, antenna section 218 is a patch or microstrip antenna having a metallized layer with a body. In the embodiment shown, the body includes a rectangular shape, but other shapes can also be used. This includes square, triangular, circular, elliptical, oval, arrayed, and other shapes. The antenna section can also include more than one microstrip feed transmission line and more than one notch portion 216. As will be described more in connection with FIG. 3, one embodiment of the antenna section 218 includes a patch or microstrip antenna having a frequency in the Ku band (e.g., about 12 GHz to 18 GHz). In other embodiments, the patch or microstrip antenna can have a frequency outside of that range.

Further, antenna systems herein can include differential and/or single-ended transmission line antenna systems. A differential transmission line radar system 222 is provided by mirroring the single-ended transmission line system, as shown by the dashed line components of FIG. 2, and appropriately spacing and sizing the microstrip lines to provide a balanced differential feed to the antenna(s). In this embodiment, microstrip line sections 208, 210, 212, and 214 and their mirrored components have been shown designed for a differential feed or antenna that includes the dashed components. The dashed line components of system 222 are generally a mirror configuration of the system 106 components and thus will not be described further. In yet other embodiments, multiple single-ended and/or differential transmission line antenna systems as those disclosed herein can be provided on a single substrate. In these cases, the microstrip line sections 208, 210, 212, and 214 will have been shaped to address the impedance matching of those specific layouts.

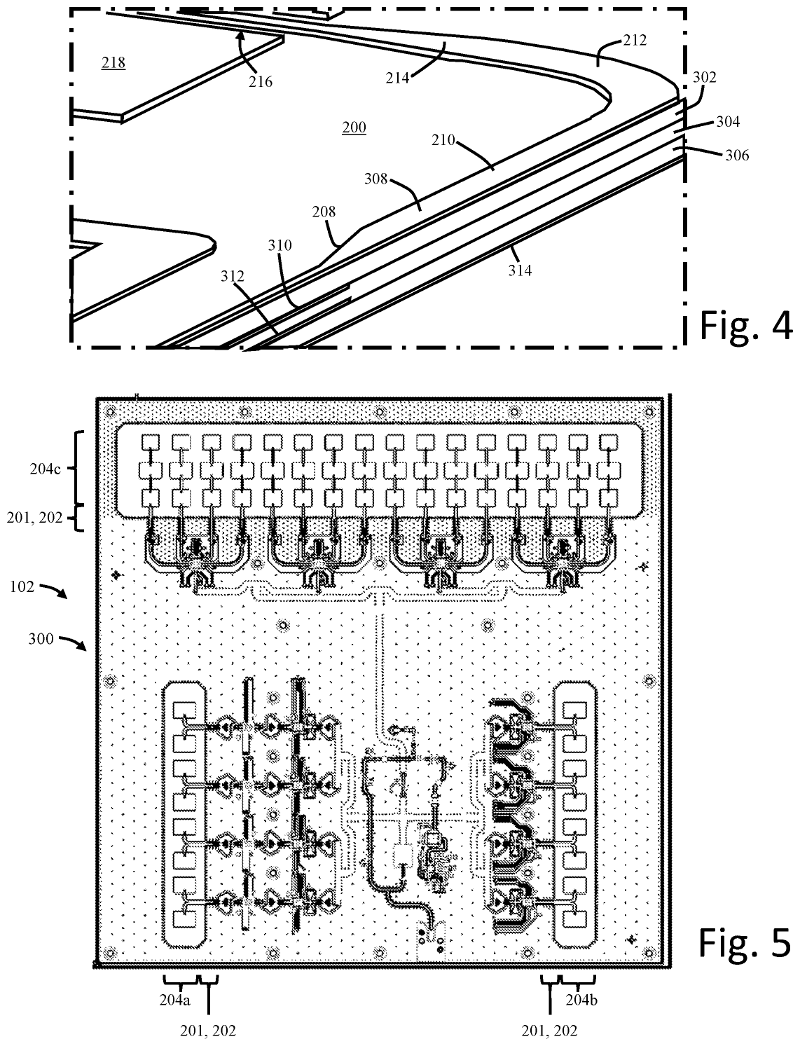

Referring now to FIGS. 3A and 4, sectional and perspective sectional views of one embodiment of substrate structure 102 are shown. Substrate structure 102 includes a multi-layer substrate 300, which can be in the form of a multi-layer printed circuit board having a plurality of dielectric layers (e.g., 302, 304, and 306) and a plurality of metallized layers (e.g., 308, 310, 312, and 314). In one embodiment, substrate structure 102 and its layers form a substrate having a plurality of heights 316, 318, 320. And, the plurality of heights can be positioned at various locations on/in the substrate structure 102, as will be described in more detail hereinafter.

FIG. 3A illustrates the cross-sectional structure including the feed portion 201, transition portion 202, and antenna portion 204 of FIG. 2. In this embodiment, feed portion 201 includes a metallization layer 308 formed on dielectric layer 302. In one embodiment, metallization layer 308 can include one or more or all the components shown in FIG. 2 (e.g., microstrip transmission lines and antenna(s)). Feed portion 201 also includes, in one embodiment, metallization layer 310 between dielectric layers 302 and 304 and metallization layer 312 between dielectric layers 304 and 306. Feed portion 201 further includes metallization layer 314 on an opposite side/face of dielectric layer 306. In this embodiment, one or more of metallization layers 310, 312, and 314 can be electrical ground layers. In one specific embodiment, all of the metallized layers 310, 312, and 314 function as electrical ground layers. In another embodiment, metallized layers 310 and 314 can be provided as ground layers. In yet another embodiment, metallized layers 312 and 314 can be provided as ground layers. Thus, any combination of one or more metallized layers between the dielectric layers can be provided as ground layers.

The transition portion 202 and antenna portion 204 include metallization layer 308 on dielectric layer 302, dielectric layers 302, 304, and 306, and metallization layer 314. In this embodiment, metallization layers 310 and 312 do not extend or do not significantly extend into transition portion 202 or antenna portion 204. In other embodiments, one or more of metallization layers 310 and/or 312 can at least partly extend into these portions. As shown in FIGS. 2 and 4, transition portion 202 includes microstrip line transition section 208, which can be used to impedance match the transmission line formed by, for example, metallization layer 308 in feed portion 201. Antenna portion 204 includes microstrip line sections 210 and 212, transition section 214, notch 216 and microstrip patch antenna 218. As previously mentioned, metallized layer 314 can act as an electrical ground layer in transition portion 202 and antenna portion 204.

Substrate 106/300 includes a plurality of heights 316, 318, and 320 and effective dielectric constants. In one embodiment, each effective dielectric constant value is dependent on the properties of the one or more dielectric layers 302, 304, and 306. This can include, for example, the height of each dielectric layer and/or the sum of the heights of multiple layers between the metallized transmission line (e.g., 308) and ground layer (e.g., 310, 312, and/or 314). For example, feed portion 201 includes a first dielectric height 316 formed by the dielectric layer 302 between metallized layer 308 and ground layer 310. Transition and antenna portions 202 and 204 have a second dielectric height 320 formed by the sum of the height of dielectric layers 302, 304, and 306 between metallized layer 308 and ground layer 314. Other dielectric heights are also possible such as height 318 formed by the sum of dielectric layers 302 and 304 between metallized layer 308 and ground layer 312.

In one embodiment, dielectric layer 302 can be a glass-filled PTFE material (or similar dielectric material) having a core thickness of approximately 168 μm, dielectric layer 304 can be a prepreg (glue, bond, or adhesive layer) (or similar material) having a thickness of approximately 101 μm, and dielectric layer 306 can be an FR-4 material (or similar material) having a core thickness of 168 μm. Metallized layers 308, 310, 312, and 314 can be copper (for example) and a layer thickness of approximately 17 μm. So configured, the patch or microstrip antenna section 218 can be provided with, for example, a center frequency of approximately 13.325 GHZ, and an operational frequency of, for example, approximately between 13.25 GHZ to 13.4 GHz. Patch or microstrip antenna can have a length L of approximately 5.6 mm and a width W of approximately 8 mm. So configured, the embodiment provides a dielectric constant value εᵣ in the antenna portion 204 of approximately 3.7 and approximately antenna center frequency of 13.325 GHz. While certain exemplary values and materials have been provided, it is not the intent to limit the disclosure to such values. For example, variations in layer thicknesses (or heights) and materials and combinations of materials can be made without substantially changing the operative results or desired antenna/system frequencies. For example, for a given patch or microstrip antenna size (e.g., length and width dimension), the effective dielectric constant value of the antenna portion 204 can be varied by up to 10% or more for a desired frequency value or range. Similarly, the number of dielectric and metallization layers used could be adjusted for different applications/frequencies.

In this manner, feed portion 201 and antenna portion 204 can include different dielectric heights or multiple layers on the same substrate structure 106/300. This allows the antenna portion 204 to have an effective dielectric constant and/or dielectric substrate height 320 that provides the microstrip patch antenna 218 with a broadband frequency range such as, for example, in the Ku band (e.g., about 12 GHZ to 18 GHz) or other desired band. One particular Ku band is the 13.25 GHz to 13.4 GHz range. The overall height of the dielectric layers (and thus the effective dielectric constant value) contributes to the amount of radiation emitted. With increased heights, like in the antenna portion 204, higher radiation occurs compared to, for example, the smaller overall substrate height(s) in feed portion 201, where little radiation is desired.

This arrangement allows for an electronic assembly system 100 (e.g., see FIG. 1), that has broadband antenna performance and is minimized in size and weight due to all components being on a single substrate (or multiple substrates of which at least the antenna substrate is reduced in size and weight) by virtue of the substrate having more than one dielectric constant value. While the illustrated embodiment shows three dielectric layers (e.g., 302, 304, and 306), more or less than three can be used. For example, two dielectric layers may be used instead of three and while attaining the same results and functionality. Furthermore, as shown in FIG. 3B, a single or monolithic dielectric layer 326 can be used that has the same or similar height arrangement as that of FIG. 3A. Further yet as shown in FIG. 3C, a single or monolithic dielectric layer 328 can also be used and still provide the same or similar height arrangements as that of FIG. 3A. The embodiments of FIGS. 3B and 3C can be fabricated by, for example, 3D printing or similar techniques. As such, the number of dielectric layers is not important so long as the dielectric height(s) and/or effective constants for the antenna components is provided by the dielectric structure. Additionally, one or more metallic and/or dielectric layers 322 and 324 as shown in FIG. 3A can also be utilized in any of the embodiments disclosed herein. These layers can, for example, have additional circuitry thereon.

Substrate 102/300 can be fabricated by providing sheets or layers of dielectric material having one or more metallized portions (e.g., on the top and/or bottom faces) (e.g., see FIGS. 3 and 4). The metallized portions are masked with a pattern (e.g., lithography) and etching is used to remove the unmasked portions to form the final metallized layer pattern or layer (e.g., as shown in FIG. 2). Once the dielectric layers and their associated metallized layers have been formed, lamination and/or bonding is used to form the final substrate or printed circuit board structure. Also, as described in connection with FIGS. 3B and 3C, the final substrate can be fabricated by 3D printing or similar techniques.

FIG. 5 illustrates another embodiment of a system 100 having a plurality of feed, transition, and antenna portions 201, 202 and 204a, 204b, and 204c, respectively. In this embodiment, the system 100 includes both transmitter and receiver sections. The transmitter section includes, for example, antenna portions 204a and 204b. Transmitter antenna portions 204a and 204b are each arranged as an array having a differential transmission feed arrangement having 2 patch or microstrip antennas (e.g., differential transmission line radar system 222 (FIG. 2)). Transmitter antenna portions 204a and 204b shown in FIG. 5 include two 1×4 antenna arrays where each antenna has a differential feed and two patch or microstrip antennas arranged, for example, as shown in FIG. 2. In other embodiments, transmission antenna portions 204a and 204b can be single-ended transmission line antenna systems as also shown in, for example, FIG. 2.

The receiver section includes, for example, antenna portion 204c which can be an array of single-ended transmission line antenna systems (as shown). In other embodiments, differential transmission line systems with multiple antennas can be used. FIG. 5 shows a receiver antenna portion 204c having a single 1×16 array where each antenna system includes 3 singled-ended patch or microstrip antennas arranged, for example, as shown in FIG. 2. In other embodiments, receiver antenna portion 204c can be a differential transmission line antenna system having two microstrip or patch antennas as also shown, for example, in FIG. 2. In accordance with the embodiments of FIGS. 2, 3A-C, and 4, the transmitter and receiver antenna portions 204a, 204b, and 204c of FIG. 5 have a dielectric constant value and/or overall substrate height that is different from that of feed portions 201. This allows antenna portions 204a, 204b, and 204c to have a broadband capability such as, for example, in the Ku band (e.g., 12 GHz to 18 GHZ). Other configurations of transmitters and receivers are also possible with more or less arrays and combinations of single and/or differential transmission line antenna systems.

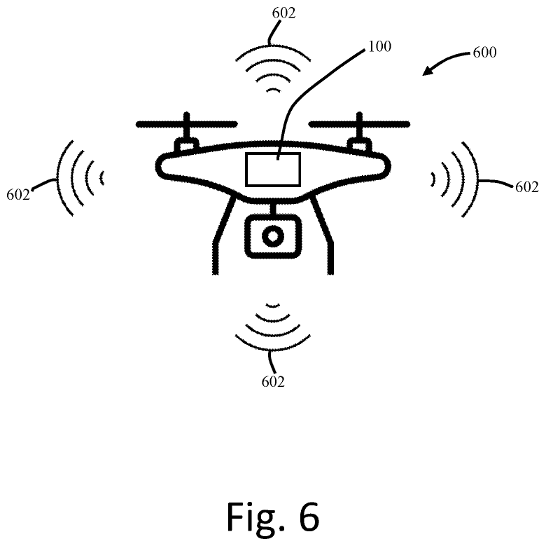

FIG. 6 illustrates one embodiment of a vehicle having system 100. The vehicle can be an aerial vehicle such as a drone or other similar vehicle, which may or may not be autonomous. In other embodiments, the vehicle can be an automobile, boat or other mobile device. In the case of an aerial drone 600, system 100 provides a small, lightweight, and broadband radar system. Use of the Ku band frequency range allows drone 600 to emit radar signals 602 from the onboard antenna to facilitate, for example, detect and avoidance navigation assistance. The small and lightweight nature of system 100 provides drone 600 with more efficient battery and power usage. It further allows drone 600 to be minimized in size and weight as well.

Hence, the systems and methods disclosed provide electronic assemblies having radar components and antennas on a single compact substrate. The substrate includes multiple dielectric heights and/or different effective dielectric constant values that permit various radar components such as transmission feed lines to be formed in association with a first dielectric height and microstrip or patch antennas to be formed in association with a second dielectric height allowing the antenna to have a desired broadband operational frequency range (e.g., inside the Ku band) or high bandwidth (e.g., inside Ku band) or high relative bandwidth (e.g. at Ku band).

Systems and methods have been described herein in accordance with at least the examples set forth below.

(A1) In one aspect, an electronic circuit assembly is described herein. The electronic circuit assembly includes a substrate having a feed portion, a transition portion, and an antenna portion. The feed portion includes a first metallization layer, a first ground layer, and a first dielectric structure having a first height between the first metallization layer and the first ground layer. The transition portion includes a tapered portion of the first metallization layer, a second ground layer, and a second dielectric structure having a second height between the first metallization layer and the second ground layer. The second height comprises a value greater than the first height. Moreover, the antenna portion includes a portion of the first metallization layer and a portion of the second dielectric structure. Further, the antenna portion has an antenna element.

(A2) In some embodiments of the electronic circuit assembly of (A1), the antenna portion comprises an antenna frequency in the range of approximately 12 to 18 gigahertz.

(A3) In some embodiments of at least one of the electronic circuit assemblies of (A1)-(A2), the feed portion comprises a differential transmission feed and the antenna portion comprises a second antenna element.

(A4) In some embodiments of at least one of the electronic circuit assemblies of (A1)-(A3), the tapered portion of the transition portion comprises a gradual widening of the first metallization layer.

(A5) In some embodiments of at least one of the electronic circuit assemblies of (A1)-(A4), the antenna element of the antenna portion comprises a length and width, and wherein the length, width, and second dielectric height are configured to generate an antenna frequency in the range of approximately 12 to 18 gigahertz.

(A6) In some embodiments of at least one of the electronic circuit assemblies of (A1)-(A5), the antenna portion comprises an effective dielectric constant value that is different than that of the feed portion.

(A7) In some embodiments of at least one of the electronic circuit assemblies of (A1)-(A6), the substrate comprises antenna power circuitry on the first dielectric layer.

(A8) In some embodiments of at least one of the electronic circuit assemblies of (A1)-(A7), the antenna portion comprises a portion of the first metallization layer that transitions from a differential transmission line to a single-ended transmission line.

(A9) In some embodiments of at least one of the electronic circuit assemblies of (A1)-(A8), the antenna portion comprises a portion of the first metallization layer that transitions from a differential transmission line to a single-ended transmission line connected to the antenna element.

(B1) In another aspect, an electronic circuit assembly is described herein. The electronic circuit assembly includes a substrate having first, second, and third dielectric layers and a feed portion, transition portion and antenna portion. The feed portion includes a first metallization layer on the first dielectric layer and a second metallization layer between the first and second dielectric layers. The feed portion has a first dielectric height between the first and second metallization layers. The transition portion includes a tapered portion of the first metallization layer and a third metallization layer on the third dielectric layer. The transition portion has a second dielectric height between the first and third metallization layers. Moreover, the second dielectric height comprises a value greater than the first dielectric height. Further, the antenna portion includes a portion of the first metallization layer having an antenna element. The antenna portion has a third dielectric height equal to or greater than the second dielectric height.

(B2) In some embodiments of the electronic circuit assembly of (B1), the antenna portion comprises an antenna frequency in the range of approximately 12 to 18 gigahertz.

(B3) In some embodiments of at least one of the electronic circuit assemblies of (B1)-(B2), the feed portion comprises a differential transmission feed and the antenna portion comprises a second antenna element.

(B4) In some embodiments of at least one of the electronic circuit assemblies of (B1)-(B3), the tapered portion of the transition portion comprises a gradual widening of the first metallization layer.

(B5) In some embodiments of at least one of the electronic circuit assemblies of (B1)-(B4), the antenna element of the antenna portion comprises a length and width, and wherein the length, the width, and the third dielectric height are configured to generate an antenna frequency in the range of approximately 12 to 18 gigahertz.

(B6) In some embodiments of at least one of the electronic circuit assemblies of (B1)-(B5), the antenna portion comprises an insert feed.

(B7) In some embodiments of at least one of the electronic circuit assemblies of (B1)-(B6), the substrate comprises antenna transmission circuitry on the first dielectric layer.

(B8) In some embodiments of at least one of the electronic circuit assemblies of (B1)-(B7), the second metallization layer comprises a ground layer.

(B9) In some embodiments of at least one of the electronic circuit assemblies of (B1)-(B8), the third metallization layer comprises a ground layer.

(C1) In another aspect, a method for constructing an electric circuit assembly is described herein. The method includes providing a substrate having first, second, and third dielectric layers and a feed portion, transition portion, and antenna portion. Moreover, the method includes forming the feed portion by providing a first metallization layer on the first dielectric layer and a second metallization layer between the first and second dielectric layers. The feed portion has a first dielectric height between the first and second metallization layers. The method further includes forming the transition portion by providing a tapered portion of the first metallization layer and a third metallization layer on the third dielectric layer. The transition portion has a second dielectric height between the first and third metallization layers. Further, the second dielectric height comprises a value greater than the first dielectric height. The method further includes forming the antenna portion by providing a portion of the first metallization layer with an antenna element. The antenna portion has a third dielectric height equal to or greater than the second dielectric height.

(C2) In some embodiments of the method of (C1), the step of forming the feed portion comprises forming a differential transmission feed and forming the antenna portion comprises forming a second antenna element.

What has been described above includes examples of one or more embodiments. It is, of course, not possible to describe every conceivable modification and alteration of the above devices or methodologies for purposes of describing the aforementioned aspects, but many further modifications and permutations of various aspects are possible and meant to be included within the disclosure herein. Accordingly, the described aspects are intended to embrace all such alterations, modifications, and variations that fall within the scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. An electronic circuit assembly, comprising:
a substrate having a feed portion, a transition portion, and an antenna portion;
the feed portion comprising a first metallization layer, a first ground layer, and a first dielectric structure having a first height between the first metallization layer and the first ground layer;
the transition portion comprising a tapered portion of the first metallization layer, a second ground layer, and a second dielectric structure having a second height between the first metallization layer and the second ground layer;
the second height comprising a value greater than the first height; and
the antenna portion comprising a portion of the first metallization layer and a portion of the second dielectric structure;
the antenna portion having an antenna element.

2. The electronic circuit assembly of claim 1, wherein the antenna portion comprises an antenna frequency in the range of approximately 12 to 18 gigahertz.

3. The electronic circuit assembly of claim 1, wherein the feed portion comprises a differential transmission feed and the antenna portion comprises a second antenna element.

4. The electronic circuit assembly of claim 1, wherein the tapered portion of the transition portion comprises a gradual widening of the first metallization layer.

5. The electronic circuit assembly of claim 1, wherein the antenna element of the antenna portion comprises a length and width, and wherein the length, width, and second dielectric height are configured to generate an antenna frequency in the range of approximately 12 to 18 gigahertz.

6. The electronic circuit assembly of claim 1, wherein the antenna portion comprises an effective dielectric constant value that is different than that of the feed portion.

7. The electronic circuit assembly of claim 1, wherein the substrate comprises antenna power circuitry on the first dielectric layer.

8. The electronic circuit assembly of claim 1, wherein the antenna portion comprises a portion of the first metallization layer that transitions from a differential transmission line to a single-ended transmission line.

9. The electronic circuit assembly of claim 1, wherein the antenna portion comprises a portion of the first metallization layer that transitions from a differential transmission line to a single-ended transmission line connected to the antenna element.

10. An electronic circuit assembly comprising:
a substrate having first, second, and third dielectric layers and a feed portion, transition portion and antenna portion;
the feed portion comprising a first metallization layer on the first dielectric layer and a second metallization layer between the first and second dielectric layers;
the feed portion having a first dielectric height between the first and second metallization layers;
the transition portion comprising a tapered portion of the first metallization layer and a third metallization layer on the third dielectric layer,
the transition portion having a second dielectric height between the first and third metallization layers,
the second dielectric height comprising a value greater than the first dielectric height; and
the antenna portion comprising a portion of the first metallization layer having an antenna element,
the antenna portion having a third dielectric height equal to or greater than the second dielectric height.

11. The electronic circuit assembly of claim 10, wherein the antenna portion comprises an antenna frequency in the range of approximately 12 to 18 gigahertz.

12. The electronic circuit assembly of claim 10, wherein the feed portion comprises a differential transmission feed and the antenna portion comprises a second antenna element.

13. The electronic circuit assembly of claim 10, wherein the tapered portion of the transition portion comprises a gradual widening of the first metallization layer.

14. The electronic circuit assembly of claim 10, wherein the antenna element of the antenna portion comprises a length and width, and wherein the length, the width, and the third dielectric height are configured to generate an antenna frequency in the range of approximately 12 to 18 gigahertz.

15. The electronic circuit assembly of claim 10, wherein the antenna portion comprises an insert feed.

16. The electronic circuit assembly of claim 10, wherein the substrate comprises antenna transmission circuitry on the first dielectric layer.

17. The electronic circuit assembly of claim 10, wherein the second metallization layer comprises a ground layer.

18. The electronic circuit assembly of claim 10, wherein the third metallization layer comprises a ground layer.

19. A method for constructing an electric circuit assembly, comprising the steps of:
providing a substrate having first, second, and third dielectric layers and a feed portion, transition portion, and antenna portion;
forming the feed portion by providing a first metallization layer on the first dielectric layer and a second metallization layer between the first and second dielectric layers;
the feed portion having a first dielectric height between the first and second metallization layers;
forming the transition portion by providing a tapered portion of the first metallization layer and a third metallization layer on the third dielectric layer,
the transition portion having a second dielectric height between the first and third metallization layers,
the second dielectric height comprising a value greater than the first dielectric height; and
forming the antenna portion by providing a portion of the first metallization layer with an antenna element,
the antenna portion having a third dielectric height equal to or greater than the second dielectric height.

20. The method of claim 19, wherein the step of forming the feed portion comprises forming a differential transmission feed and forming the antenna portion comprises forming a second antenna element.
